(19) United States
(12) Patent Application Publication
(10) Pub. No.: US 2002/0195510 A1
(43) Pub. Date: Dec. 26, 2002

(54) Paper-guiding structure of shredding apparatus

(75) Inventor: Shin-Fu Lin, Taipei (TW)

Correspondence Address: VOLPE AND KOENIG, P.C., SUITE 400, ONE PENN CENTER, 1617 JOHN F. KENNEDY BOULEVARD, PHILADELPHIA, PA, 19103, US

(73) Assignee: Primax Electronics Ltd., Taipei (TW)

(21) Appl. No.: 09/992,382

(22) Filed: Nov. 6, 2001

(30) Foreign Application Priority Data
Jun. 21, 2001 (TW) 090210506

(51) Int. Cl. B02C 18/16

(52) U.S. Cl. 241/236

(57) ABSTRACT

A paper-guiding structure of a shredding apparatus is disclosed. The apparatus includes a first shaft, a second shaft disposed with the first shaft in parallel, wherein a channel is formed between the first shaft and the second shaft for a paper to pass therethrough. A plurality of cutters are staggeredly sleeved and fixed on the first and second shafts respectively and transmitted by the first and second shaft to rotate for cutting paper passing through the channel. A plurality of guiding plates are disposed in the space between every two adjacent cutters for each shaft, and movably sleeved on the first or second shaft. Each of the guiding plates is integrally formed and has a continuous surface facing the channel to eliminate slits through which shredded paper sneaks out of the guiding path.

### FIELD OF THE INVENTION

The present invention relates to a paper-guiding structure of a shredding apparatus, and more particularly to a paper-guiding structure of a shredding apparatus used for an office routine work.

### BACKGROUND OF THE INVENTION

A shredding machine is an essential machine in an office. FIGS. 1A and 1B are a top view and a cross-sectional view illustrating partial structures of a conventional shredding machine, respectively. A first and a second series of cutters 111 and 112 are sleeved on a first shaft 101 and a second shaft 102, respectively, with interlaced cutter arrangement as shown in FIG. 1A. Every two adjacent cutters 111 and 113 are interleaved with a spacer 121. Further, upper and lower guiding elements 131 and 132, as indicated by shadowed portions in FIG. 1B, are combined around and arranged in close contact with the spacers. FIG. 1C is a three-dimensional view illustrating partial structures of the guiding element combination of FIG. 1B. The upper guiding element 131 consists of a set of downward fins 1311 protruding from a base 1312 . The lower guiding element 132 consists of a set of upward fins 1321 protruding from a base 1322 and corresponding to the set of downward fins 1311. By combining the guiding elements 131 and 132 together around the spacers 121, paper can be properly guided. As shown in FIG. 1A, if the guiding elements 131 and 132 are tightly attached to the side surfaces of the spacers 121, the shredded paper will not enter a gap between the spacer and the guiding element. However, owing to the possible errors when manufacturing and/or assembling, the guiding elements can hardly be tightly attached to the spacer when the paper passes through a channel 14 and cut by the cutters 111, 112. Hence, the shredded paper will enter the gap frequently, which results in the conditions of non-smoothly shredding action and/or paper jam and further causes troubles for the user.

Therefore, the purpose of the present invention is to develop a shredding apparatus to deal with the above situations encountered in the prior art.

### SUMMARY OF THE INVENTION

It is therefore an object of the present invention to provide a shredding apparatus for preventing the shredded paper from entering the gap between the spacer and guiding element.

According to an aspect of the present invention, there is provided a shredding apparatus including a first shaft, a second shaft disposed with said first shaft in parallel, wherein a channel is formed between said first shaft and said second shaft for a paper to pass therethrough, a plurality of cutters staggeredly sleeved and fixed on said first and second shafts and transmitted by said first and second shaft to rotate, respectively, for cutting said paper when said paper passes through said channel, wherein a space is existent between every two adjacent cutters of the same shaft, and a plurality of guiding plates, each of which is disposed in one said space, includes a spacer ring for penetrating therethrough one of said first and said second shafts, and is integrally formed for having a continuous surface facing said channel.

Preferably, each guiding plate has at least two holes serving as: said spacer ring for movably sleeving on one of said first and second shafts, and a mounting ring for passing therethrough a mounting shaft to fix relative positions of said guiding plates.

Preferably, the continuous surface is formed of two linear planes with a curved portion of said spacer ring therebetween.

For example, the guiding plates are made of plastic material.

The present invention may best be understood through the following description with reference to the accompanying drawings, in which:

### BRIEF DESCRIPTION OF THE DRAWINGS

FIGS. 1A-1B are a top view and a cross-sectional view illustrating partial structures of a conventional shredding machine;

FIG. 1 C is a three-dimensional view illustrating partial structures of a guiding element combination of FIG. 1B; and

FIG. 2 is a cross-sectional view illustrating a preferred embodiment of a shredding apparatus according to the present invention;

FIGS. 3A-3B are a side view and a three-dimensional view illustrating a preferred embodiment of a guiding plate of FIG. 2; and

FIG. 4 is a top view illustrating the preferred embodiment of FIG. 2.

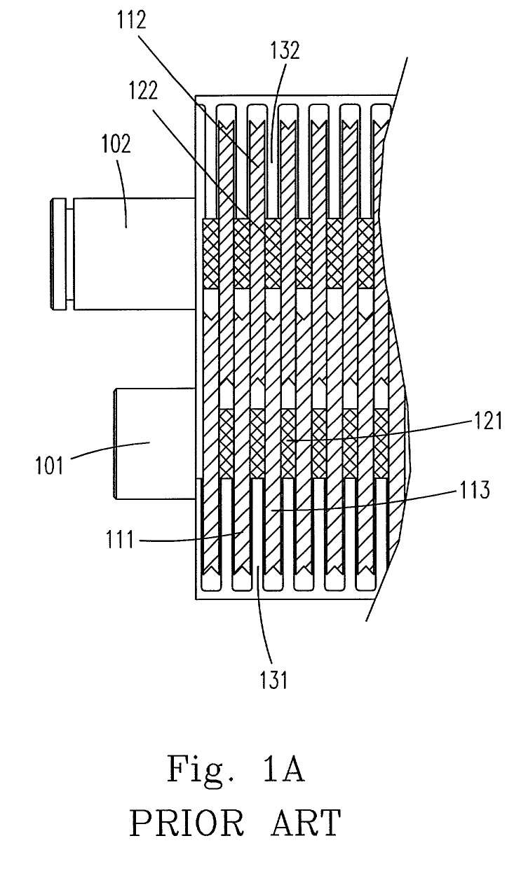

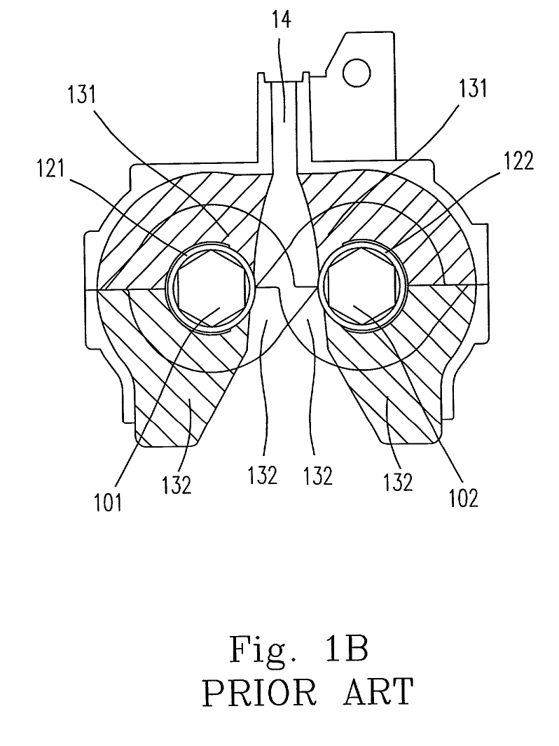

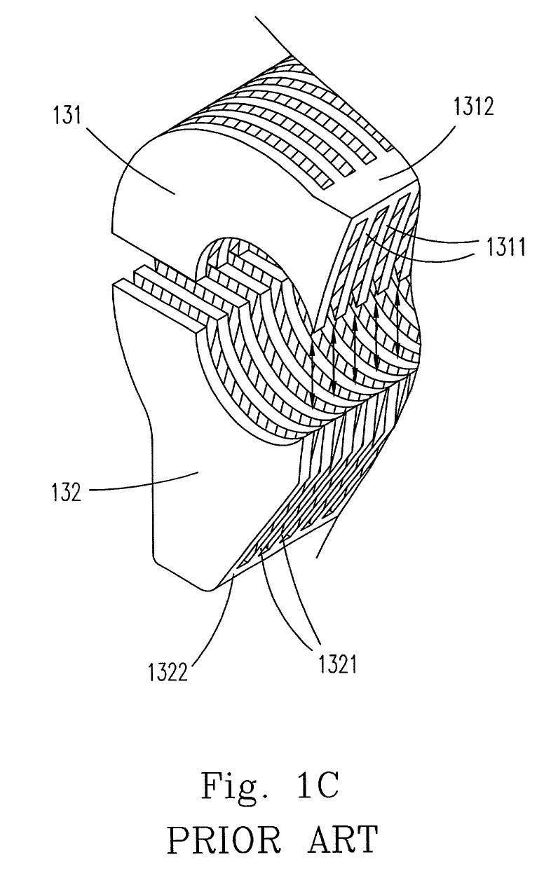

### DETAILED DESCRIPTION OF THE PREFERRED EMBODIMENTS

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

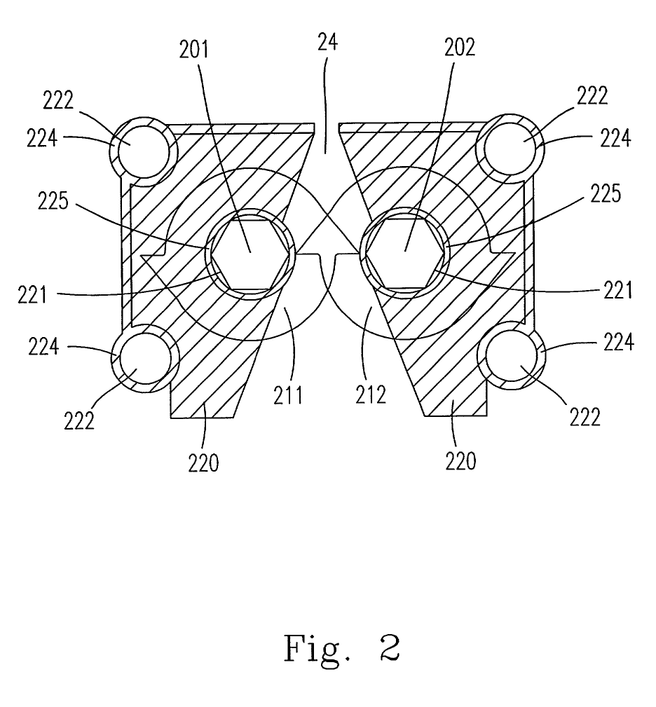

FIG. 2 is a cross-sectional view illustrating a preferred embodiment of a shredding apparatus according to the present invention. As shown in FIG. 2, a first shaft 201 is disposed with a second shaft 202 in parallel to form a channel 24 for a paper to pass through. A first and a second series of cutters 211 and 212 are staggeredly sleeved and fixed on the first and second shafts 201 and 202, respectively. Further, every two adjacent cutters on the same shaft are interleaved with a guiding plate 220 simultaneously performing spacer and paper-guiding functions. The cutters 211 and 212 fixed on the first and second shafts 201, 202 is transmitted by the first and second shafts 201, 202 to rotate, respectively, for cutting the paper which is passing through the channel 24.

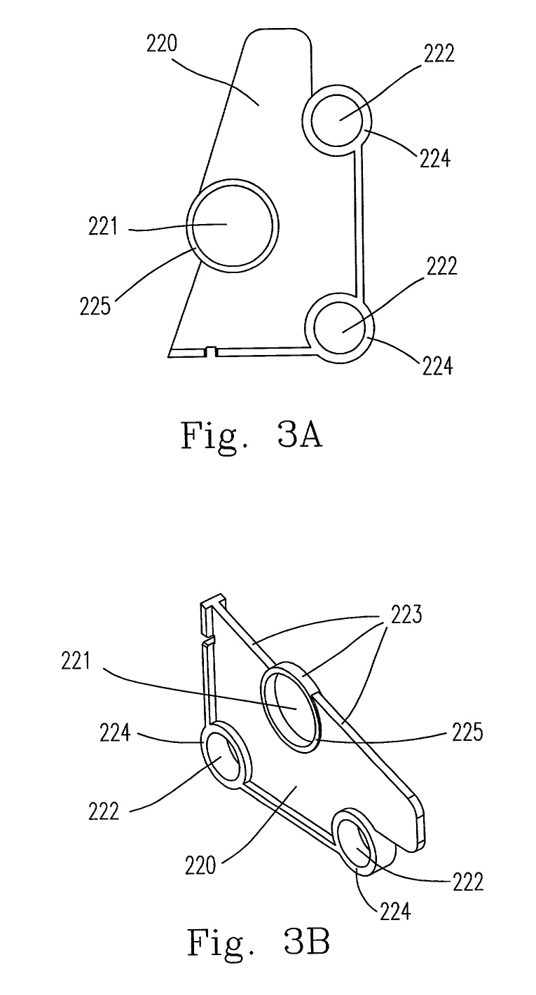

FIGS. 3A-3B are a side view and a three-dimensional view illustrating the preferred embodiment of FIG. 2. The guiding plate 220 is integrally formed of plastic or metal material. As shown in FIGS. 2, 3A and 3B, each guiding plate 220 has at least two holes 221 and 222 serving as a spacer ring 225 and a mounting ring 224, respectively. The spacer ring 225 is used for movably sleeving on the first shaft 201 or the second shaft 202 while the mounting ring 224 is used for passing therethrough a mounting shaft (not shown) to fix the guiding plates 220 in position relative to one another. One edge of each guiding plate 220 forms a continuous surface 223 facing the channel 24. As shown in FIG. 3B, the continuous surface 223 is formed of two linear plane with a curved portion of the spacer ring therebetween. Because the surface of the guiding plate 220 facing the channel 24 is continuous, i.e. there is no slit existent in the surface, all shredded paper will remain in the guiding path.

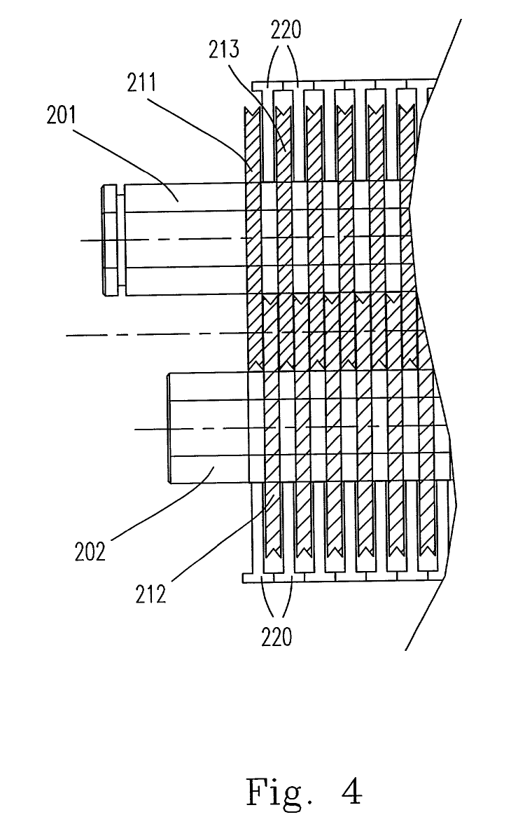

FIG. 4 is a top view illustrating the preferred embodiment of FIG. 2. Every two adjacent cutters 211 and 213 are interleaved with one of the guiding plate 220 on the first shaft 201. The cutters 211 and 212 are staggeredly sleeved on the first shaft 201 and the second shaft 202, respectively. The assembling condition is shown in FIG. 4. According to the present invention, the disadvantage of the prior art that the shredded paper enters the gap between the spacer and the guiding element will be avoided because each guiding plate is integrally formed and no more space exists between the guiding element and the spacer.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A shredding apparatus, comprising:
a first shaft;
a second shaft disposed with said first shaft in parallel, wherein a channel is formed between said first shaft and said second shaft for a paper to pass therethrough;
a plurality of cutters staggeredly sleeved and fixed on said first and second shafts and transmitted by said first and second shaft to rotate, respectively, for cutting said paper when said paper passes through said channel, wherein a space is existent between every two adjacent cutters of the same shaft; and
a plurality of guiding plates, each of which is disposed in one said space, includes a spacer ring for penetrating therethrough one of said first and said second shafts, and is integrally formed for having a continuous surface facing said channel.

2. The shredding apparatus according to claim 1 wherein each said guiding plate has at least two holes serving as:
said spacer ring for movably sleeving on one of said first and second shafts; and
a mounting ring for passing therethrough a mounting shaft to fix relative positions of said guiding plates .

3. The shredding apparatus according to claim 1 wherein said continuous surface is formed of two linear planes with a curved portion of said spacer ring therebetween.

4. The shredding apparatus according to claim 1 wherein said guiding plates are made of plastic material.

5. The shredding apparatus according to claim 1 wherein said guiding plates are made of metal material.
